(19) United States
(12) Patent Application Publication
(10) Pub. No.: US 2011/0281195 A1
(43) Pub. Date: Nov. 17, 2011

(54) FUEL CELL ADHESIVE AND PROCESS OF MAKING THE SAME

(75) Inventors: Timothy J. Fuller, Pittsford, NY (US); Vindo Kumar, Pittsford, NY (US)

(73) Assignee: GM GLOBAL TECHNOLOGY OPERATIONS, INC, Detroit, MI (US)

(21) Appl. No.: 12/778,470

(22) Filed: May 12, 2010

(51) Int. Cl. H01M 8/24; C08F 10/14; B32B 37/12; C08F 10/06; C08F 10/08; C08F 210/00; C08F 10/02

(52) U.S. Cl. 429/467; 526/348; 526/170; 526/89; 526/210; 526/235; 526/209; 526/194; 526/348.2; 526/348.3; 526/348.6; 526/351; 526/352; 156/334

(57) ABSTRACT

A fuel cell adhesive comprises a polyolefin adhesive having a bonding strength sufficient to adhere two fuel cell stack components together. The bonding strength of the polyolefin adhesive is less than the cohesive strength of any of the fuel cell stack components such that two adhesively bonded fuel cell stack components can be easily separated and re-joined without causing any mechanical damages to the fuel cell stack components. The polyolefin adhesive may be prepared by polymerizing at least an α-olefin monomer in the presence of a molecular weight controlling agent.

### TECHNICAL FIELD

The field to which the disclosure generally relates includes fuel cells and fuel cell manufacturing processes.

### BACKGROUND

A fuel cell stack typically comprises a series of fuel cell stack components such as a membrane electrode assembly (MEA) that includes an anode and a cathode situated on opposite sides of a solid polymer electrolyte membrane, gas diffusion media (GDM), bipolar plates, gaskets, and water cooling/management plates. The fuel cell stack components are stacked face-to-face in a particular order to form multiple serially linked individual electrochemical cells. For high energy density, the fuel cell stack components typically have a very delicate and thin sheet configuration. It is therefore challenging to achieve perfect alignment and spacing/contact tolerance among the stack components in a fuel cell stack. Similarly, elastomeric gaskets without adhesive are difficult to assemble within a fuel cell stack because they are flexible and they have a tendency to twist. This makes proper alignment of fuel cell stack components time consuming and prone to misassembly.

To address this issue, fuel cell stack components can be adhesively bonded together using conventional adhesives. Most adhesives leach out contaminants that can poison the sensitive catalysts, proton conductive membrane or other functional coatings on some of the stack components. Many adhesives simply do not meet the demanding operating temperature requirements (−30° C. to 130° C.) or several thousand operating hours durability requirement due to their poor chemical stability. Some special adhesives such as certain silicone and fluoroelastomer adhesives are expensive. It has been found that it is difficult to disassemble the adhesively bonded fuel cell stack without tearing the MEA or causing the other stack components, which may be brittle, to break.

Thus there is a need for a fuel cell adhesive and an adjustable fuel cell stack that can be easily assembled, disassembled and re-assembled without incurring damages to the fuel stack components.

### SUMMARY OF EXEMPLARY EMBODIMENTS OF THE INVENTION

One embodiment of the invention includes a fuel cell comprising a plurality of fuel cell stack components. At least two of the fuel cell stack components are joined together using a polyolefin adhesive disposed on the peripheral areas of at least one of the fuel cell stack components.

Another embodiment of the invention includes a fuel cell adhesive that comprises a polyolefin adhesive having a bonding strength sufficient to adhere two fuel cell stack components together. The bonding strength of the polyolefin adhesive is less than the cohesive strength of any of the fuel cell stack components such that two fuel cell stack components in a fuel cell stack can be easily separated, re-aligned and re-joined without causing any mechanical damages to the fuel cell stack components.

Another embodiment of the invention includes a process of making a fuel cell stack comprising:
a. Providing a plurality of fuel cell stack components including at least a membrane electrode assembly, a bipolar plate, and a gas diffusion medium;
b. Applying a polyolefin adhesive to the peripheral area of at least one of the fuel cell stack components;
c. Stacking the fuel cell stack components together to form a fuel cell stack;
d. Applying a compressive force to the fuel cell stack such that the polyolefin adhesive bonds its neighboring fuel cell stack components together; and
e. Optionally, separating the fuel cell stack components for re-alignment or replacement of a fuel cell stack component.

Other exemplary embodiments of the present invention will become apparent from the detailed description provided hereinafter. It should be understood that the detailed description and specific examples, while disclosing exemplary embodiments of the invention, are intended for purposes of illustration only and are not intended to limit the scope of the invention.

Unless explicitly stated, the process embodiments described herein are not constrained to a particular order or sequence. Additionally, some of the described embodiments or elements thereof can occur or be performed at the same point in time.

### BRIEF DESCRIPTION OF THE DRAWINGS

Exemplary embodiments of the present invention will become more fully understood from the detailed description and the accompanying drawings, wherein:

FIG. 1 is a schematic cross-sectional view of a section of a fuel cell stack according to one embodiment.

FIG. 2 is a schematic cross-sectional view of a section of a fuel cell stack according to another embodiment.

FIG. 3 is an expanded perspective view of a section of a fuel cell stack according to one embodiment.

FIG. 4 is an expanded perspective view of a section of a fuel cell stack according to another embodiment.

### DETAILED DESCRIPTION OF EXEMPLARY EMBODIMENTS

The following description of the embodiment(s) is merely exemplary in nature and is in no way intended to limit the invention, its application, or uses.

A fuel cell is typically made of a series of fuel cell stack components pressed together in a particular order. A fuel cell stack usually comprises multiple electrochemical cells stacked together in a serial configuration. Fuel cell stack components may include, but are not limited to, a membrane electrode assembly which itself is formed from an anode and a cathode situated on opposite sides of a solid polymer electrolyte membrane (all fuel cell components as well), gas diffusion media, bipolar plates, gaskets, sub-gaskets, cooling plates, water management plates, and end plates. Any fuel cell stack component and any functional combination of fuel cell stack components may be used to construct the fuel cell as described herein. Several examples of a fuel cell stack and fuel cell stack components can be found in U.S. Pat. Nos. 6,165,634, 5,700,595, and 5,736,269.

A polyolefin adhesive may be applied to the peripheral area of a fuel cell stack component to facilitate the fuel cell assembly process and to improve the fuel cell's performance. The polyolefin adhesive may be applied to any of the fuel cell stack components using any coating, printing, or other deposition method. The polyolefin adhesive may comprise an olefin polymer having a glass transition temperature of −30° C. or less. The molecular weight of the olefin polymer is controlled such that the adhesive exhibits sufficient adhesive bonding strength or tack to hold fuel cell stack components together. Additionally, the adhesive bonding strength is less than the cohesive strength of the fuel cell stack components having contact with the adhesive. In other words, the adhesive joint between fuel cell stack components can be subsequently separated for re-alignment and/or re-assembly without damaging the fuel cell stack components. The polyolefin adhesive exhibits good adhesive properties over the temperature range of −30° C. to about 130° C. for an extended period of time. The adhesive bonding strength may be activated or increased by compressing adhesive applied fuel cell stack components together under a safe pressure. Such a pressure may range from about 1 psi to about 500 psi, depending on the particular combination of fuel cell stack components. For example, a pressure between 50 psi to 200 Psi may be applied to a fuel cell stack. Additionally, the polyolefin adhesive is found to reduce the diffusion or leakage rate of fuel cell reactant gases through the peripheral areas.

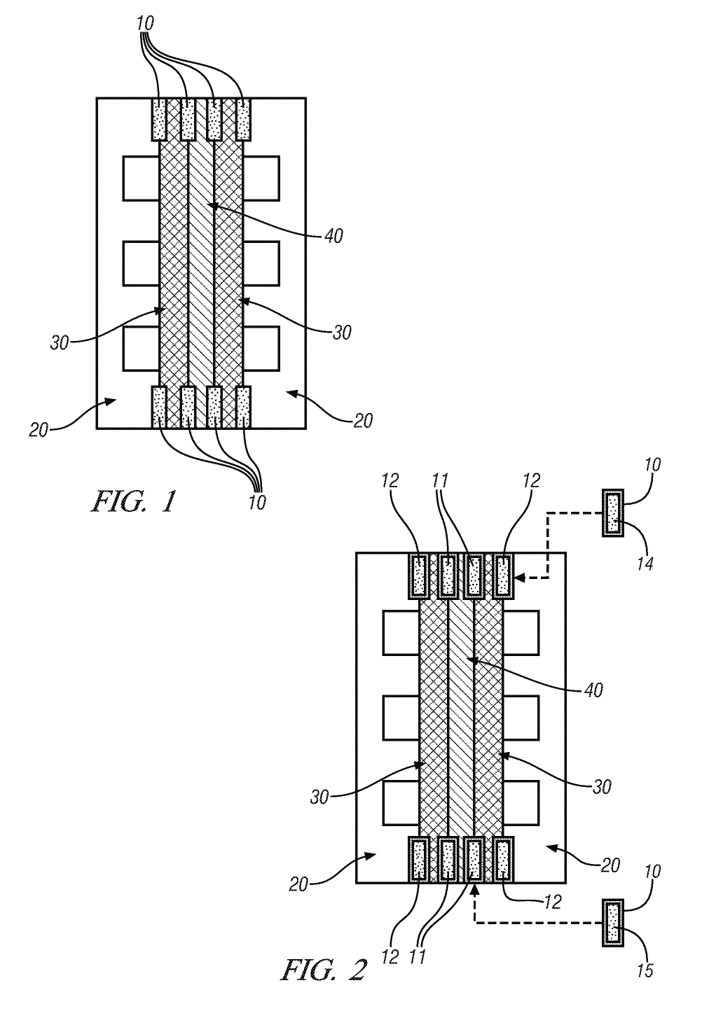

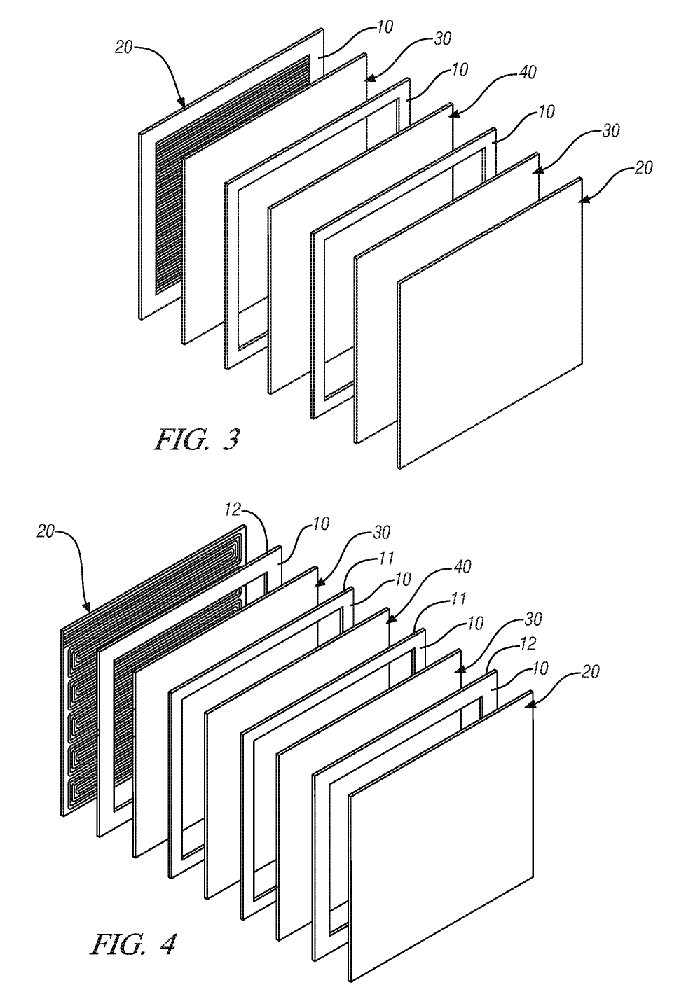

FIG. 1 is a schematic cross-sectional view of a section of a fuel cell stack in one embodiment. FIG. 3 is an expanded perspective view of the fuel cell stack section in the same embodiment. A polyolefin adhesive 10 is applied to the peripheral areas of the bipolar plate 20 and membrane electrode assembly 40. The bipolar plates 20, membrane electrode assembly 40, and gas diffusion media 30 are brought together in the order as shown in FIG. 3, and compressed together to form a fuel cell stack. As shown in FIG. 1, the polyolefin adhesive 10 joins the fuel cell stack components together and provides a barrier to diffusion and leakage of fuel cell reactant gases. Additional edge sealant may be applied to the side of the fuel cell stack to completely block the leakage of reactant gases. The pressure applied to form such fuel cell stack is sufficient to activate the adhesive bonding, but not to cause mechanical damages to the fuel cell stack components. The applied pressure may be monitored by a pressure gauge, or by a pressure indicating film such as Pressurex O Tactile indicating film available from Sensors Products Inc., in New Jersey. The adhesively joined fuel cell stack components may be subsequently peeled apart for re-alignment, replacement, and re-assembly. Since the polyolefin adhesive is made to have an adhesive bonding strength less than the cohesive strength of the fuel cell components, such re-alignment and re-assembly may be easily accomplished without incurring any damages to the functional fuel cell components.

Gaskets and sub-gaskets may also be used as fuel cell stack components to help alignment of active fuel cell areas and to control spacing/thickness tolerance in a fuel cell stack. The gasket and sub-gasket may be made of elastomeric materials, plastic film materials (such as polytetrafluoroethylene, copolymers of ethylene and tetrafluoroethylene, polyvinylidene fluoride, poly(ethylene naphthalate), and the like), fiber reinforced composite sheet materials, or graphite materials as disclosed in US Patent Application publication number 20060240306. The gasket and sub-gasket materials may be cut to a shape to match the peripheral areas of the fuel cell stack components. Thin sheet gasket and sub-gasket materials can twist, shift, or otherwise move around readily during the fuel cell assembly process, causing mis-alignment and mis-assembly. To solve the problem, the polyolefin adhesive may be applied to the surface of the gasket and sub-gasket. The gasket and sub-gasket can be easily fixed to the designed fuel cell stack component peripheral areas by applying a pressure to activate adhesive bonding between the gasket and the fuel cell stack component. The gasket and sub-gasket can also be peeled off for re-alignment or replacement without damaging the fuel cell stack components.

FIG. 2 is a schematic cross-sectional view of a section of a fuel cell stack in another embodiment where a gasket 12 and a sub-gasket 11 are used. FIG. 4 is an expanded perspective view of a section of the fuel cell stack according to the same embodiment. The polyolefin adhesive 10 is disposed on both sides of the gasket sheet material 14 and sub-gasket sheet material 15 as shown in FIG. 2. The gasket 12 and sub-gasket 11 may be disposed on the corresponding peripheral areas of the bipolar plate 20, gas diffusion medium 30 and/or membrane electrode assembly 40, before all fuel cell stack components are aligned and stacked together to form a fuel cell stack. The gasket 12 and sub-gasket 11 may be made of a film such as a poly(ethylene naphthalate) film, or an elastomer sheet such as a silicone rubber sheet or a fluoroelastomer sheet. The polyolefin adhesive 10 may be applied to the gasket 12 and sub-gasket 11 by a coating, printing, spraying, silk screening, or by other deposition methods known to a skilled artisan.

Alternatively, the polyolefin adhesive may be applied to the peripheral areas of the bipolar plates 20, the gas diffusion media 30 and/or the membrane electrode assembly 40 when the gasket and/or sub-gasket are used. In that case, the polyolefin adhesive does not necessarily have to be applied on the gasket 12 or sub-gasket 11 surfaces.

Some of the fuel cell stack components may have functional coatings on the surface which the polyolefin adhesive comes in contact with. The bonding strength of the polyolefin adhesive is always less than the bonding strength of the functional coating to its corresponding fuel cell stack component. Functional coatings on fuel cell stack components are therefore not adversely affected by the assembling, re-aligning, or re-assembling processes. For example, a polar plate may have a water management coating for reducing the water contact angle as described in US Patent Application Publication number 20060194095. When applied to the peripheral area of the bipolar plate, the polyolefin adhesive does not adversely affect the water management function or the mechanical integrity of the coating. Similarly, the polyolefin adhesive bonding strength to a membrane electrode assembly (MEA) is lower than the bonding strength of the anode and cathode to the ion-exchange membrane in the MEA. Additionally, the polyolefin adhesive does not migrate beyond the peripheral areas into the active area of the fuel cell stack components.

The polyolefin adhesive comprises an α-olefin polymer. The α-olefin polymer may be a homopolymer or a copolymer, having at least one chemical structural unit represented by the formula:

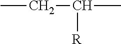

where R is an alkyl radical having at least 3 carbons and more preferably R is 4 carbon atoms such that the α-olefin polymer is 1-hexene. Such a homopolymer typically has a glass transition temperature of about −30° C. or lower. For example, the glass transition temperatures of poly(1-hexene) and poly(1-pentene) are approximately −50° C. and −40° C. respectively, and such low glass transition temperatures provide the polyolefin adhesive with its desirable fuel cell adhesive properties. The α-olefin polymer may be synthesized by polymerizing at least one α-olefin monomer having a chemical structure represented by the formula: CH₂═CH—R, where R is an alkyl radical having at least 3 carbon atoms. Examples of the monomer represented by the formula may include, but are not limited to, 1-isopentene, 1-octene, 1-decene, 3-methyl-1-butene, 1-heptene, 1-nonene, 1-dodecene. 1-undecene, 1-tridecene, 1-behenylene and any alkyl substituted derivatives thereof.

Other co-monomers may of course be used to copolymerize with the α-olefin monomer described above. Those other co-monomers may be included at 0% to about 50% by weight based on the total weight of the final olefin polymer. Suitable co-monomers may include, but are not limited to, olefins, (methyl)acrylates, vinyl, and maleic monomers. Olefin co-monomers may include, but are not limited to, ethylene, propylene, cyclohexene, butylenes, isoprene, chloroprene, butadiene, styrene, and divinylbenzene. (Meth)acrylate co-monomers may include, but are not limited to, methacrylic acid, acrylic acid, methyl methacrylate, ethyl acrylate, acrylonitrile, butyl acrylate, butyl methacrylate, hydroxyethyl acrylate, ethylhexyl acrylate, acrylamide, methacrylamide, hexyl acrylate and lauryl acrylate. Vinyl co-monomers may include, but are not limited to, vinyl acetate, vinyl chloride, vinylidene fluoride, vinylidene chloride, vinyl ethyl ether, vinyl methyl ether, and vinyl pyrrolidone. Maleic co-monomers may include, but are not limited to, maleic anhydride, maleic acid, and maleic esters. Other suitable co-monomers that may also be used include, but are not limited to, poly(cyclo-olefins) such as those derived from cyclopentene, cycloheptene, and cyclooctene, which are polymerized with transition metal catalysts that carry out ring opening metathesis polymerization.

The olefin polymer can be synthesized from the monomers described above by any addition polymerization method, including Ziegler-Natta polymerization, radical polymerization, plasma polymerization, and metallocene catalysis polymerization. In Ziegler-Natta polymerization, catalysts based on titanium, zirconium, hafnium, vanadium and aluminum compounds may be used. Examples of Ziegler-Natta catalysts may include, but not limited to, titanium(III) chloride, titanium(IV) chloride, vanadium chloride, aluminum chloride, methylaluminoxane ([CH₃AlO]ₙ) and organometallic trialkyl aluminum compounds, such as (CH₃)₆Al₂, [Al(C₂H₅)₃]₂ and [AlCl(C₂H₅)₂]₂. The Ziegler-Natta catalysts may comprise a mixture of at least two of the metal compounds described above. For example, titanium(III) chloride may be combined with a cocatalyst, [AlCl(C₂H₅)₂]₂. TiCl₄ and [Al(C₂H₅)₃]₂ may be used together as another catalyst example. Both homogeneous and heterogeneous Ziegler Natta catalysts may be used. Homogeneous Ziegler Natta catalysts may include, but are not limited to, (Cp)₂TiCl₂, and [Cp₂Zr(CH₃)CH₃B(C₆F₅)₃] where aluminum co-catalysts may not be needed. Cp is referred to as cyclopentadiene herein. Metallocene catalysis polymerization can also be used to produce the olefin polymer. In particular, Kaminsky catalysts and post-metallocene catalysts may be used to polymerize the olefin monomers. Examples of metallocene catalysts include, but are not limited to, catalysts represented by the following chemical structures:

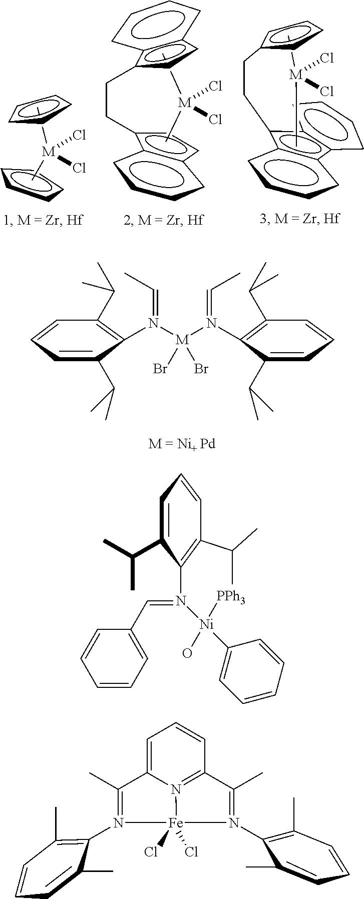

In one embodiment, the olefin polymer is an α-olefin homopolymer having a structure represented by the chemical formula:

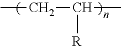

where R is any alkyl radical having at least 3 carbon atoms and n is positive integer representing the degree of polymerization. The α-olefin homopolymer can be derived from an α-olefin through Ziegler-Natta polymerization or metallocene catalysis polymerization. Non-limiting examples of α-olefin homopolymers include poly(1-pentene), poly(1-hexene), poly(1-octene), poly(1-decene), and poly(1-(3-methyl)butene).

In other embodiments, the olefin polymer may be an olefin copolymer. The olefin copolymer can be derived from at least one of the α-olefin monomers described above and at least one of the other co-monomers described above. Non-limiting examples of olefin copolymers include copolymers derived from 1-hexene and at least one other olefin co-monomer such as ethylene, propylene, butene, pentene, hexene, heptene, octene, nonene, decene, undecene, dodecene, tridecene, tetradecene, pentadecene, hexadecene, styrene, octadecene, nonadecene, eicosene, butadiene and behenylene. The olefin copolymer may also be derived from the α-olefin monomer described above and at least one vinyl co-monomer such as vinylidene fluoride and hexafluoropropylene.

The molecular weight of the olefin polymer is controlled during polymerization to provide the polyolefin adhesive with the processing characteristics and adhesive bonding strength that is lower than the cohesive strength of a fuel cell stack component yet sufficient to bond fuel cell stack components together. Relatively high catalyst to monomer/initiator ratios may be used to produce controlled relatively low molecular weight in certain cases. The addition of a molecular weight controlling agent to a polymerization mixture, however, is found to be very effective. Examples of molecular weight controlling agents for Ziegler-Natta and metallocene catalysis polymerizations may include, but are not limited to, organo-zinc compounds, hydrogen, oxygen, alcohols, ethers, compounds having Si—H bond, compounds having—Si(CH₃)₃ bonds and alkyl halides. Organo-zinc compounds may include, for example, diethyl zinc, dimethyl zinc, dipropyl zinc, di-isopropyl zinc and dibutyl zinc. In radical polymerization, the molecular weight controlling agent may include mercaptans, alkyl halides, and oxygen. The amount of the molecular weight controlling agent in the polymerization mixture may be present at about 0.1% to about 20% and more preferably about 1% to about 10%, by weight, based on the total monomer weight. The amount of the molecular weight controlling agent may range from about 0.1% to about 40%, and more preferably, about 1% to about 15% based on the total weight of the catalysts in the polymerization mixture.

The olefin polymer prepared without the molecular controlling agent described above may contain a portion of high molecular weight polymer or polymer gel. The high molecular weight or gel portion in the polyolefin adhesive may generate an overall or a local bonding strength higher than the cohesive strength of a fuel cell stack component. The high molecular weight or gel portion in the polyolefin adhesive may also reduce the pressure activated adhesive bonding characteristic that is desirable when assembling a fuel cell stack. The high molecular weight or gel portion can result in too high a solution or melt viscosity, making the process of applying the polyolefin adhesive difficult, if not impossible. In particular, a high solids solution of high molecular weight resin can result in a non-flowable or non-pumpable adhesive mixture. A high molecular weight or gel portion in the polyolefin adhesive can also create high viscosity pockets, gel particles or fibrils, called “stringers”. When the adhesive is applied to a fuel cell stack component using a silk screen process, for example, the “stringers” may aggregate to form spider-web like sections on the silk screen. The “stringers” may block the pores in the silk screen or otherwise making the process of adhesive application un-reliable.

The olefin polymer may be prepared by suitably polymerizing the corresponding monomer(s) by, for example, bulk polymerization, heterogeneous polymerization, solution polymerization, suspension polymerization or emulsion polymerization. After polymerization, the olefin polymer can be purified through conventional purification techniques known to skilled artisans to remove un-reacted monomers, impurities, and catalysts. Any compounds in the polymerization mixture that may contaminate the fuel cell stack components are removed. The neat olefin polymer or its solution/dispersion in a solvent may then be used as a hot melt adhesive or liquid adhesive.

Other additives and polymer resins may be combined with the olefin polymer to form a formulated polyolefin adhesive. Other additives may include, but not limited to, antioxidants, pigments, tackifying agent, parafins, rheology modifiers, organic solvents, adhesion promoters, reactive diluents, organic and inorganic fillers including electrically conductive fillers such as graphite, carbon black, carbon fibrils, and metal powders. Other polymer resins may be added to the olefin polymer at an amount less than 50% by weight based on the total weight of the adhesive weight. Non-limiting examples of other polymer resins may include, but not limited to, polyethylene, polypropylene, ethylene/propylene copolymer (EPM), ethylene/propylene/diene terpolymer (EPDM), polytetrafluoroethylene (PTFE), copolymers of ethylene and tetrafluoroethylene, polyvinylidene fluoride polymers and copolymers, polydimethylsiloxane, ethylene-vinyl acetate copolymers, ethylene-vinyl alcohol copolymers, polyurethanes, acrylic polymers, and the like.

The polyolefin adhesive may be applied using a silk screen printing process. The screen may be made of any suitable material including fabrics, film materials and composites. A pattern of holes are created in the screen through photolithography, physical puncturing with punch outs, chemical etching, laser etching, or other mechanisms on the silk screen. The polyolefin adhesive is squeezed through the patterned holes from one side and transferred to the fuel cell stack components on the other side of the screen. Both rotary screens and flat screens may be used to apply the adhesive. In one example, a pattern of holes are created on a flat screen only in areas corresponding to the peripheral areas of a fuel cell stack component. The flat screen is then laid over the fuel cell stack component such that the areas of the patterned holes on the screen overlap the peripheral areas of the fuel cell stack component where the adhesive is to be applied. The polyolefin adhesive is poured on the screen opposite to the fuel cell component side of the screen. A squeegee (a round edge rubber blade or a rubber roller) is used to scrape the adhesive with pressure across the screen to squeeze the polyolefin adhesive through the holes on the screen, resulting in deposition of the polyolefin adhesive only on the peripheral area of the fuel cell component. The coating amount can be easily adjusted by changing the size of the holes, density of the holes and/or pattern of the holes on the silk screen.

Alternatively, the adhesive may be applied to the fuel cell stack components by flexographic printing, transfer coating/printing, hot melt slot die coating, spraying, silk-screening, or other adhesive dispensing and deposition methods.

It is also found that the polyolefin adhesive described herein can be easily removed from a fuel cell stack component by gentle rubbing or wiping with an organic solvent.

### Example 1

### Preparation of an Olefin Polymer, poly(1-hexene), Using Ziegler Natta Polymerization without a Molecular Weight Controlling Agent

Under nitrogen atmosphere in a glove bag, the following reagents were combined in a 500-mL, high-density polyethylene screw cap bottle equipped with a magnetic stir bar: 1-hexene (monomer, 37.5 mL, 25 grams), toluene (105 mL), diethyl aluminum chloride in toluene (co-catalyst, 40 mL, 1.8 M or 25 wt. % solution in toluene), and titanium trichloride-aluminum chloride reduced (TiCl₃.AA, 5.6 grams, catalyst). The lid of the bottle was secured and the bottle was placed in an ice-water bath with magnetic stirring. The polymerization was allowed to proceed for about 16 hours. Methanol was added slowly to the reaction mixture to quench the active catalyst and then the reaction mixture was added in portions to methanol using a Waring blender. The polymer was precipitated into 1-gallon of methanol. The polymer was filtered and then washed with water (1 liter) and then with more methanol (1 liter). After collection by filtration and vacuum drying, a white poly[1-hexene] was obtained in 75% yield. A 30 wt. % solids polyolefin adhesive solution was made in mesitylene in a sealed glass jar with magnetic stirring in an oil bath maintained at about 70° C. The polyolefin adhesive solution was difficult to handle and silk screen due to very high viscosity as 10 and 30 wt. % solids solution. When a silk screen printing process was attempted using this adhesive solution, significant amount of “stringer” was observed.

Similar experiments were carried out by significantly increasing the catalyst and co-catalyst amount relative to the monomer (1-hexene) amount. The resulting olefin polymers contain smaller amount of high molecular weight portion and “stringers” were still observed, but in lesser amounts, in the silk screen printing process.

### Example 2

### Preparation of an Olefin Polymer, poly(1-hexene), Using Ziegler Natta Polymerization with a Molecular Weight Controlling Agent

Under dry nitrogen atmosphere inside a glove bag, the following reagents were combined in a 500-mL, high-density polyethylene screw cap bottle equipped with a magnetic stir bar: 1-hexene (monomer, 37.5 mL, 25 grams), toluene (105 mL), diethyl aluminum chloride in toluene (co-catalyst, 40 mL, 1.8 M or 25 wt. % solution in toluene), and titanium trichloride-aluminum chloride reduced (catalyst, TiCl₃.AA, 5.6 grams). The lid of the bottle was secured and the bottle was placed in an ice-water bath under magnetic stirring. After stirring for about 1 hour, diethyl zinc (molecular weight controlling agent, 8 mL, 1.1 M or 15 wt. % solids in toluene) was added under nitrogen via a syringe. The polymerization was allowed to proceed for 16 hours. Methanol was added slowly to the reaction mixture to quench the active catalyst and the reaction mixture was added in portions to methanol using a Waring blender. The polymer was precipitated into 1-gallon methanol. The polymer was filtered and washed with water (1 liter) and subsequently with more methanol (1 liter). After collection by filtration and vacuum drying, a white poly[1-hexene] (18.8 grams) was obtained in 75.2% yield. A 30 wt. % solids polyolefin adhesive solution was made in mesitylene in a sealed glass jar under magnetic stirring in an oil bath maintained at about 70° C. The polymer solution was filtered through an 85-micron Teflon mesh (available from Sefar America) and subsequently through a 5-micrometer pore-sized, Millipore filter under nitrogen pressure. The resultant solution was used to silk screen the adhesive onto a PEN (polyethylene naphthalate) support film (to be used as a fuel cell sub-gasket) without the formation of stringers. The polyolefin adhesive solution exhibited sufficient bonding strength under pressure to hold fuel cell stack components together. The polyolefin adhesive is very effective in keeping the fuel cell stack component in alignment with each other and in preventing the stack component from shifting, sliding or rotating relative to each other in assembling process. The fuel cell stack components bonded by the poly(1-hexene) adhesive can be easily separated for re-alignment and re-assembly without causing any mechanical damages. The poly(1-hexene) adhesive does not contaminate or adversely affect any of the functional components in the fuel cell stack.

Copolymers of 1-hexene with other olefin co-monomers such as ethylene and propylene, can be produced according the procedures described in example 2 in the presence of diethyl zinc as a molecular weight controlling agent. Similar satisfactory results can be achieved using such copolymers as a polyolefin fuel cell adhesive.

The above description of embodiments of the invention is merely exemplary in nature and, thus, variations thereof are not to be regarded as a departure from the spirit and scope of the invention.

What is claimed is:

1. A fuel cell adhesive comprising a polyolefin adhesive having a bonding strength sufficient to adhere two fuel cell stack components together;
said bonding strength being less than the cohesive strength of any of the fuel cell stack components such that two fuel cell stack components in a fuel cell stack can be easily separated and re-joined without causing any mechanical damages to said fuel cell stack components.

2. A fuel cell adhesive as set forth in claim 1, wherein said polyolefin adhesive comprises an α-olefin polymer having a glass transition temperature of −30° C. or less.

3. A fuel cell adhesive as set forth in claim 2, wherein said α-olefin polymer is prepared in the presence of a molecular weight controlling agent.

4. A fuel cell adhesive as set forth in claim 3, wherein said molecular weight controlling agent is selected from the group consisting of organo-zinc compounds, hydrogen, oxygen, alcohols, ethers, compounds having Si—H bond, and alkyl halides.

5. A fuel cell adhesive as set forth in claim 3, wherein said α-olefin polymer is prepared from at least one olefin monomer represented by the formula of CH₂═CH—R; wherein R is an alkyl moiety having at least 3 carbon atoms.

6. A fuel cell adhesive as set forth in claim 5, wherein said α-olefin polymer is a homopolymer prepared from 1-hexene, 1-pentene, 1-isopentene, 1-octene, 1-decene, 3-methyl-1-butene, 4-methyl-1-pentene, 1-heptene, 1-nonene, 1-dodecene. 1-undecene, 1-tridecene, or 1-behenylene.

7. A fuel cell adhesive as set forth in claim 6, wherein said α-olefin polymer is a poly(1-hexene) prepared in the presence of a diethyl zinc molecular weight controlling agent.

8. A fuel cell adhesive as set forth in claim 5, wherein said α-olefin polymer is a copolymer prepared by including about 5 to about 50% by weight of a co-monomer comprising at least one of ethylene, propylene, butene, pentene, hexene, heptene, octene, nonene, decene, undecene, dodecene, tridecene, tetradecene, pentadecene, hexadecene, octadecene, styrene, nonadecene, eicosene, butadiene or behenylene.

9. A fuel cell comprising a plurality of fuel cell stack components, at least two of said fuel cell stack components being joined together using a polyolefin adhesive disposed on the peripheral areas of at least one of said fuel cell stack components.

10. A fuel cell as set forth in claim 9, wherein said polyolefin adhesive comprises an α-olefin polymer having a glass transition temperature less than about −30° C.

11. A fuel cell as set forth in claim 10, wherein said α-olefin polymer is prepared in the presence of a molecular weight controlling agent selected from the group consisting of diethyl zinc, hydrogen, oxygen, alcohols, ethers, compounds having Si—H bond, and alkyl halides.

12. A fuel cell as set forth in claim 10, wherein said fuel cell stack components include at least one bipolar plate, one gas diffusion layer, and one membrane electrode assembly.

13. A fuel cell as set forth in claim 12, wherein said fuel cell stack components further include a gasket and/or a sub-gasket upon which said polyolefin adhesive is disposed.

14. A fuel cell as set forth in claim 12, said polyolefin adhesive is disposed on the peripheral area of at least one of said fuel cell stack components.

15. A process of making a fuel cell stack comprising:
providing a plurality of fuel cell stack components including at least a membrane electrode assembly, a bipolar plate, and a gas diffusion medium;
applying a polyolefin adhesive to the peripheral area of at least one of said fuel cell stack components; said polyolefin adhesives having a bonding strength less than the cohesive strength of any of said fuel cell stack components;
stacking said fuel cell stack components together to form a fuel cell stack;
applying a compressive force to said fuel cell stack such that said polyolefin adhesive bonds its neighboring fuel cell stack components together.

16. A process as set forth in claim 15 further comprising separating the fuel cell stack components bonded together by said polyolefin adhesive for re-alignment or replacement of a fuel cell stack component.

17. A process as set forth in claim 15, wherein said fuel cell stack components further include at least a gasket and/or a sub-gasket.

18. A process as set forth in claim 17, wherein said polyolefin adhesive is disposed on said gasket and/or sub-gasket.

19. A process as set forth in claim 15, wherein said polyolefin adhesive comprises an α-olefin polymer having at least one monomer unit represented by the chemical formula 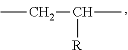
wherein R is an alkyl moiety having at least 3 carbon atoms.

20. A process as set forth in claim 15, wherein said polyolefin adhesive comprises an α-olefin polymer prepared in the presence of a molecular weight controlling agent selected from the group consisting of dialkyl zinc, hydrogen, oxygen, alcohols, ethers, compounds having Si—H bond, and alkyl halides.

21. A process as set forth in claim 15, wherein said polyolefin adhesive is applied to said fuel cell component(s) by a silk screen or hot melt resin dispensing and coating method.
